(19) United States
(12) Patent Application Publication
(10) Pub. No.: US 2008/0128212 A1
(43) Pub. Date: Jun. 5, 2008

(54) OIL SCOOP ASSEMBLY FOR THE OIL SUPPLY OF MACHINE PARTS ROTATING RELATIVE TO EACH OTHER

(76) Inventors: Richard Utzat, Essen (DE); Ralf Schafer, Koln (DE); Antonio Correia, Koln (DE); Aleksej Katsnelson, Sankt Augustin (DE); Holger Seidl, Siegburg (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/945,915

(22) Filed: Nov. 27, 2007

(30) Foreign Application Priority Data
Nov. 27, 2006 (DE) 10 2006 055 808.1

(51) Int. Cl. F16N 7/16; F16D 13/74

(52) U.S. Cl. 184/11.4; 192/70.12

(57) ABSTRACT

The invention relates to an oil scoop assembly (2) for using in a stationary housing with machine parts, rotatable therein around a rotational axis. The oil scoop assembly comprises an oil return element (3), which can be connected to the housing and has a wiper (10) for abutting an outer face (21) of a machine part, at least one channel (6), which is supplied by the wiper (10) with oil and which ends in an annular channel (7), extending coaxially to the rotational axis A; and an oil scoop wheel (4), connectable to one of the machine parts, with a plurality of blades (24), distributed around the rotational axis A and which extend into the annular channel (7) and, when the oil scoop wheel (4) rotates relative to the oil return element (3), delivers oil from the annular channel (7). The invention relates further to a clutch arrangement (32) with such an oil scoop assembly (2).

### TECHNICAL FIELD

The present invention relates to an oil scoop assembly for the oil supply of a machine part, rotating in a stationary housing around a rotational axis and running in an oil sump, or machine parts, rotating relative to each other. The invention relates, furthermore, to a multi-disc clutch with an oil scoop assembly of the above named type.

### BACKGROUND OF THE INVENTION

A hydraulically actuated multi-disc clutch is known from U.S. Publication No. 2007/0193846 A1. For actuating a piston is provided, which is axially displaceable in a hydraulic chamber and which can exert an axial force onto the disc set. The hydraulic chamber is connected to a pump, which acts hydraulically on the piston. The hydraulic system comprises a joint oil filling, which serves for the actuation of the piston as well as for cooling of the disc set.

From JP 11-082537 a wet multi-disc clutch is known, which comprises an outer disc carrier, in which outer discs are held non-rotatably, and an inner disc carrier, on which the inner discs are mounted non-rotatably. On the inner disc carrier a disc with wiper arms is mounted, which, when rotating, deliver oil through axial openings of the disc into the inner chamber of the multi-disc clutch.

### SUMMARY OF THE INVENTION

The present invention proposes an improved oil scoop system which ensures a reliable lubrication and cooling supply of rotating machine parts, as well as to provide especially a multi-disc clutch with improved lubricating and cooling possibilities.

The present invention proposes an oil scoop assembly for use in a stationary housing with machine parts rotatable therein relative to each other around a rotational axis, comprising an oil return element, connectable to the housing, which has a wiper for abutting an outer face of one of the machine parts; at least one channel, which is supplied with oil by the wiper and which ends in an annular channel extending coaxially to the rotational axis; and an oil scoop wheel, connectable to one of the machine parts, with a plurality of blades, distributed around the rotational axis and which extend into the annular channel and, when the oil scoop wheel rotates relative to the oil return element, deliver oil from the annular channel.

The advantage of the oil scoop assembly according to the invention is, that the machine parts, when rotating around the rotational axis, are provided reliably with oil. The embodiment with a stationary oil return element and an oil scoop wheel rotating relative thereto, is especially effective, as oil, which has reached the annular channel, is pumped by the blades of the oil scoop wheel forcibly into the inner chamber of the machine part. As the oil return element together with the wiper is held stationary in the housing, a directed oil volume flow is produced. The use of the wiper is especially advantageous, as this, when the machine part is rotating, wipes off oil, located on the outer face, and guides it in the direction towards the channel. Thus, a large oil volume flow can be delivered to the channel and, thus, finally to the rotating components, for example a multi-disc clutch.

The wiper extends preferably in an axial direction, wherein it is directed in the mounted condition along the outer face of the rotating machine part and is abutting the same. According to the preferred embodiment the wiper is formed in the cross-section blade-like or C-like, which has advantageous effects on the oil amount which can be wiped-off from the outer face. The oil scoop assembly has to be mounted in the stationary housing in such a way, that the radial channel extends generally vertically, so that the oil flows, because of the gravitational force, radially inwardly into the annular channel. Of course, also, a plurality of channels can be provided, which extend in the radial direction and end in the annular chamber.

It is contemplated that the oil scoop wheel can be connected to the same machine part, which outer face is abutted by the wiper of the oil return element. The oil return element and the oil scoop wheel act, in this case, directly together. Preferably the wiper, the channel and the annular channel form one piece and form together the oil return element. According to one embodiment the oil return element comprises a disc-like base body, on which the radial channel, the annular channel and the wiper are attached. Here, the channel is, preferably, arranged on the base body, wherein a side wall of the channel is formed by the upper face of the base body. The base body is, preferably, formed slightly conical. The annular channel has, when seen in a longitudinal section, a generally C-like profile, which is open in the direction towards the machine part, so that the blades of the oil scoop wheel can extend into the annular chamber. Preferably, the annular channel is formed by an outer annular web, an inner annular web, extending coaxially hereto, and a bottom, which is part of the base body. According to one embodiment the radial inner end of the channel ends axially neighboring the annular channel, wherein in the bottom of the annular channel a connecting through opening is provided. The through opening is, preferably, arranged in a portion of the bottom arranged radially inwardly. In this way an undercut is formed, which ensures, that oil, which has reached the annular channel, cannot escape to the outside anymore. According to one embodiment, the oil scoop wheel comprises a ring, on which the blades are attached axially projectingly. When the machine part rotates, the blades run in the annular channel around the rotational axis. The ring has, preferably, axial through openings, which are arranged in circumferential direction neighboring the blades and through which the oil is pumped by the blades in the direction towards the clutch. The blades are formed such, that they, when the oil return element rotates, deliver oil in the axial direction through the through openings. For this, they have in a radial view a blade-like shape.

According to a second variant, the oil scoop wheel is connectable to a different machine part than the machine part, which the oil return element with its wiper abuts. This variant is especially advantageous, when the axial connection possibilities on the machine part, rotating in the oil sump, are limited. Preferably, the wiper and the channel are made to form one part and form together the oil return element. The oil return element is connected according to a preferred embodiment with its channel to a connection channel formed in the housing and ending in the annular channel. Thus, in this variant the oil return element and the oil scoop wheel interact directly via the channels arranged in the housing. The annular channel is open in the housing radially inwardly, i.e. the oil supply takes place here from the annular channel into the inner chamber of the machine part arranged coaxially thereto. Preferably, the oil scoop wheel comprises a ring with radial through openings, wherein the blades project blade-like in circumferential direction, neighboring the through openings, from the ring, to deliver, when rotating in a preferred rotational direction, oil through the through openings radially inwardly.

The solution of the above named object consists, furthermore, in a multi-disc clutch with an oil scoop assembly according to the first variant, comprising an outer disc carrier with outer discs, which outer disc carrier being rotatable around a rotational axis and running in an oil sump; an inner disc carrier with inner discs, which inner disc carrier being rotatably held around the rotational axis relative to the outer disc carrier in a housing, wherein the inner discs and the outer discs are arranged axially alternatingly and form a disc set; a bottom part, formed onto one of the two disc carriers, with a plurality of circumferentially distributed axial through openings, which bottom part delimits a ring-like clutch chamber formed between the two disc carriers; an oil return element, rigidly connected to the housing, which oil return element has a wiper, abutting above the oil sump an outer face of the outer disc carrier, a channel connected to the wiper, and an annular channel connected to the channel coaxially to the rotational axis; and an oil scoop wheel, connected to the bottom part, with a plurality of blades, distributed in circumferential direction and arranged in the area of the through openings and which extend into the annular channel and, when the bottom part rotates relative to the housing, deliver oil from the annular channel through the through openings into the clutch chamber.

The multi-disc clutch according to the invention has the above named advantages of a reliable oil supply and, thus, a good lubrication and cooling, which leads to a long service-life. The use of the stationary oil return element is especially advantageous, as the gravitational force contributes to the fact, that oil flows through the radial channel from the outer end radially inwardly into the annular channel. Oil, which has reached into the annular channel, is pumped by the blades of the rotating oil scoop wheel into the inner chamber of the multi-disc clutch. By means of the wiper a large amount of oil can be wiped-off from the outer disc carrier and can be directed in the direction of the channel. The oil catcher unit used here can have, especially, any of the embodiments, named in connection with the first variant.

According to one embodiment the bottom part is rigidly connected to the outer disc carrier, i.e. especially formed integrally. The axial through openings, which connect the inner chamber of the housing to the inner chamber of the clutch, are preferably arranged in a radially inward portion of the bottom part. Thus, it is ensured, that the oil flows into the clutch radially within the inner disc carrier, so that it gets between the discs, to lubricate and to cool these. For this, the inner disc carrier is, preferably, formed sleeve-like or in form of a hollow shaft and has in the area of the disc set radial through openings, through which the oil can flow outwards to the disc set. For completeness, it shall be understood that the bottom can obviously also be connected to the inner disc carrier or formed integrally therewith. According to a preferred improvement the bottom part has radially inwardly a hub, which extends axially into the hollow shaft. Preferably, a sealing ring is provided between an end of the inner disc carrier and the bottom part. Thus, it is prevented, that the oil, flowing into the clutch chamber, flows on in the inside along the bottom radially to the outside, without getting into contact with the discs. It is rather achieved, that the oil flows within the inner disc carrier axially into the area of the disc set, to reach through the radial through openings to the discs. The oil flows, then, between the discs radially outwards and leaves the clutch chamber again through gaps arranged on the outside.

A further solution of the above named object consists in a multi-disc clutch with an oil catcher arrangement according to the second variant, comprising a housing with a sleeve portion, in which, radially inwardly, an annular channel is formed, extending coaxially to a rotational axis; an inner disc carrier with inner discs, which inner disc carrier being rotatably held in the housing around the rotational axis, wherein the inner disc carrier is formed sleeve-like and has in the area of the annular channel a plurality of circumferentially distributed radial through openings; an outer disc carrier with outer discs, which outer disc carrier being rotatably held relative to the inner disc carrier around the rotational axis and running in an oil sump, wherein the inner discs and the outer discs are arranged axially alternatingly and form a disc set; an oil return element, rigidly connected to the housing and which oil return element has a wiper abutting above the oil sump an outer face of the outer disc carrier and a channel connected to the wiper, which channel is connected to the annular channel for the oil supply; an oil scoop wheel, connected to the inner disc carrier, with a plurality of circumferentially distributed blades, which are arranged in the area of the through openings and extend into the annular channel and, when the inner disc carrier rotates relative to the housing, deliver oil from the annular channel through the through openings into the clutch chamber. This multi-disc clutch offers in analogy the same advantages, as the above named solution. The oil scoop unit, used here, can especially have each of the embodiments named in connection with the second variant.

According to one embodiment the sleeve portion has a connection channel with an outer entering opening to which the channel of the oil return element is connected and an inner exit opening ending in the annular channel. In this case, the connection channel is, in the mounted condition of the multi-disc clutch, orientated generally vertically, so that the gravitational force can be used for the oil supply. Preferably, the sleeve-like inner disc carrier has in the area of the disc set radial through openings. For the oil lubrication of the multi-disc clutch it is, especially, advantageous, when the inner diameter of the inner disc carrier increases from the plane of the first through openings in the area of the oil scoop wheel up to the plane of the second through openings in the area of the disc set. Thus, due to the centrifugal force existing when the inner disc carrier rotates, the oil automatically flows in the direction of the larger cross-section, i.e. in direction of the disc set. Also in this solution the outer disc carrier has a bottom part, preferably formed integrally therewith, with a hub, into which a shaft can be non-rotatably inserted.

According to one embodiment, which is valid for both above named variants, the outer disc carrier has a cylindrical outer face, along which the wiper extends longitudinally. In this case, the wiper is orientated generally parallel to the rotational axis, i.e. outside of the oil sump in an area above the clutch. Between the stationary wiper and the rotating outer disc carrier, a minimal gap is formed, so that frictional losses are prevented. The components of the oil scoop assembly can be manufactured for example from a plastic material, especially by an injection-moulding process, but also as form parts from metal sheet. The oil scoop wheel can be connected to the corresponding machine part, for example, by means of clipping, pressing or screwing. The oil return element is, preferably, axially supported on a shoulder arranged in the housing and, thus aligned relative to the outer disc carrier. For attaching on the housing, especially screw connections or adhesive bonding connections are possible.

These and other features and advantages of this invention will become more apparent to those skilled in the art from the detailed description of a preferred embodiment. The drawings that accompany the detailed description are described below.

### BRIEF DESCRIPTION OF THE DRAWINGS

The invention can be better understood on reading the following description given purely by way of example and made with reference to the accompanying drawing.

FIG. 1 is an oil return element of an oil scoop assembly according to the invention in a first embodiment:
a) in an axial front view;
b) in a longitudinal sectional view according to section line A-A of view 1A); and
c) in an axial rear view.

FIG. 2 is an oil scoop wheel for an oil return element of FIG. 1:
a) in an axial front view;
b) in a longitudinal sectional view according to the section line A-A of view 2a); and
c) in an axial rear view.

FIG. 3 is a multi-disc clutch according to the invention in a first embodiment with an oil scoop assembly according to FIGS. 1 and 2 in a longitudinally sectioned exploded view.

FIG. 4 is the multi-disc clutch according to FIG. 3 in a completely assembled condition in a longitudinal sectional view.

FIG. 5 is the multi-disc clutch of FIG. 4 with drawn-in path of the oil flow.

FIG. 6 is an oil return element of an oil scoop assembly according to the invention in a second embodiment:
a) in an axial rear view;
b) in a longitudinal sectional view according to the section line A-A of view 6a); and
c) in a sectional view according to the section line B-B of view 6b).

FIG. 7 is an oil scoop wheel for an oil return element of FIG. 6:
a) in a sectional view; and
b) in a longitudinal sectional view.

FIG. 8 is a multi-disc clutch according to the invention in a second variant with an oil scoop assembly according to FIGS. 6 and 7 in a longitudinal sectional view.

FIG. 9 is the multi-disc clutch of FIG. 8 with the drawn-in path of the oil flow.

### DETAILED DESCRIPTION OF A PREFERRED EMBODIMENT

Following, FIGS. 1 and 2 are described together. They show a two-part oil scoop assembly 2, which has an oil return element 3 and an oil scoop wheel 4, interacting therewith. The oil return element 3 is inserted into a not shown housing, in which it is held stationary. The oil scoop wheel 4 is to be mounted on a machine part, held rotatably in the housing, with which it rotates around a rotational axis relative to the stationary oil return element 3.

The oil return element 3, which is shown as a separate part in FIGS. 1a) to 1c), comprises a disc-like base body 5, a channel 6, mounted on the base body 5 and extending from radially outwards to radially inwards, as well as an annular channel 7, arranged radially inwardly and in which the radial channel 6 ends. The base body 5 is formed as a cone disc and has in a circumferential portion arranged radially outwards a first axial through opening 8, serving as an entering opening to the channel 6. Radially inwardly, the base body 5 has a second axial through opening 9, serving as a connection of the channel 6 to the annular channel 7. Furthermore, the base body 5 comprises a wiper 10, which is formed on the cone disc and extends in the axial direction. The wiper 10 serves to abut an outer face of the rotating machine part, to be able to wipe-off, when the machine part is rotating in a preferred rotational direction, oil from the outer face and to deliver it in a direction towards the entering opening 8. For this, the wiper 10 is formed C-like in a cross-section and has an inner wall portion 12, which has a curvature adapted to the radius of the outer face of the machine part, a rear wall 13 and an outer wall portion 14, which extends with a radial distance to the inner wall portion 12, i.e. approximately over half its circumferential extension. The free axial end of the wiper 10 is chamfered relative to the longitudinal axis A.

It is visible, that the entering opening 8 and the through opening 9 have, respectively, a rectangular cross-section, wherein the shape of the entering opening 8 is adapted to the cross-section of the wiper 10 and is limited inwardly by a concave edge and outwardly by a convex edge, extending more or less parallel thereto. The entering opening 8 has a similar contour, which inner concave edge is adapted to the radius of the annular channel 7. The annular channel 7 has—when seen in a longitudinal sectional view—an approximately C-like profile and comprises an outer ring web 15, an inner ring web 16, extending coaxially thereto, and a bottom 17, which is formed by the base body 5. Thus, the entering opening 8 is formed on a portion of the bottom 17 arranged radially inwards, i.e. neighboring the inner ring web 16, so that oil, which has reached the annular channel 7, cannot flow back into the radial channel 6 because of the centrifugal forces. The annular channel 7 is open in the axial direction towards the machine part, so that the oil can be delivered by the oil scoop wheel 4 from the thus formed annular opening 18 into the interior of the machine part for cooling and lubrication purposes.

The radial channel 6 is arranged on the disc-like base body 5, wherein the side wall of the channel 6, facing the machine part, is formed by the upper face of the base body 5. The disc-like base body 5 is formed slightly conical, so that the channel 6 ends axially neighboring relative to the annular channel 7, wherein the entering opening 8 and the annular opening 18 are arranged on a common plane. Radially outwards, the base body 5 has a flange portion 19 for the axial support on a corresponding radial shoulder of the housing. For the rotational locking, at least one bore 20, into which a not shown screw is inserted and which can be screwed into a corresponding threaded bore in the housing, is provided in the flange portion 19. The oil return element 3 is molded integrally with the wiper 10, the channel 6 and the annular channel 7 from a plastic material, wherein other materials are not excluded.

The oil scoop wheel 4, which is shown as a separate component in FIGS. 2a to 2c, comprises an annular disc 22 with circumferentially distributed openings 23 and axially projecting blades 24, which are, respectively, arranged circumferentially adjacent to the openings 23. Furthermore, circumferentially distributed bores 25 are provided, which serve for the axial fixation on the here not shown machine part. It is visible, that the blades 24 have in a radial view a blade-like shape, so that they, when rotating around the rotational axis in a preferred rotational direction, deliver oil into the corresponding opening 23, arranged respectively in front in circumferential direction. In the mounted condition of the oil scoop assembly 2, the circumferentially distributed blades 23 engage in the annular channel 7 of the oil return element 3, to pump the oil, existing there, into the inner chamber of the machine part. Therefore, the mean diameter of the annular disc 22 corresponds to the mean diameter of the annular channel 7. Further, the radial width of the annular disc 22 and of the blades 24, attached thereon, correspond approximately to the radial width of the annular channel 7, and the axial height of the blades 24 corresponds approximately to the axial depth of the annular channel 7, so that as a whole the largest possible oil volume flow can be delivered from the annular channel 7 into the interior of the machine part. The annular disc 22 has a central bore 26, through which a not shown drive shaft, to be connected to the machine part, can be passed.

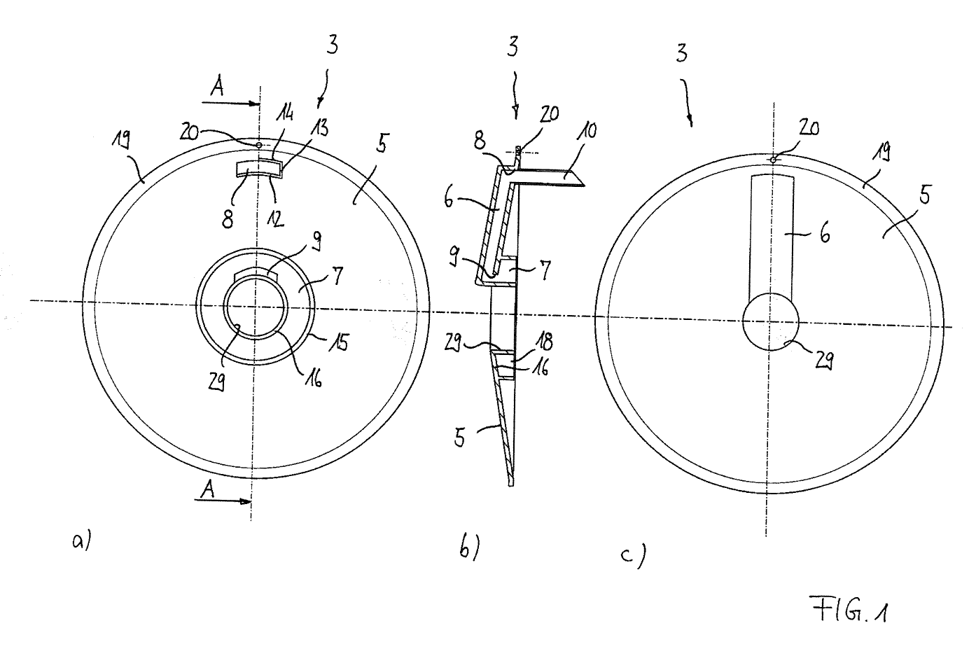

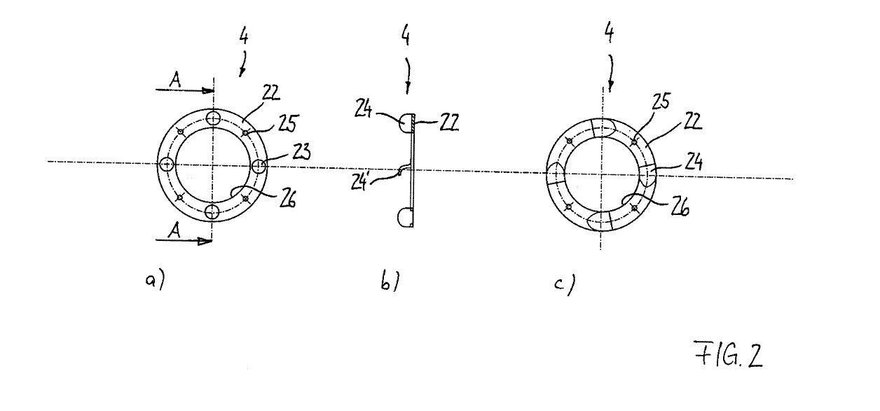

FIGS. 3 to 5, which are described together in the following, show a clutch arrangement 32, which has, besides the oil scoop assembly shown in FIGS. 1 and 2, a multi-disc clutch 33 as a machine part, an axial actuating device 34 for actuating the multi-disc clutch 33 as well as an electromotor 61 for driving the axial actuating device 34. The clutch arrangement 32 comprises, further, a housing 35, in which the above named components are accommodated or are mounted on the same.

The multi-disc clutch 33 comprises two components, rotatable relative to each other around the rotational axis A, namely an outer disc carrier 26, in which outer discs 37 are non-rotatably and axially movable accommodated, and an inner disc carrier 38, on which the inner discs 39 are held non-rotatably and axially movable. The outer discs 37 and the inner discs 39 are arranged axially alternatingly and form together a disc set 40. The inner disc carrier 38 is formed as a hollow shaft, which has at its free end a flange 42 for connecting to a not shown drive train. In the area of the disc set 40, several radial through openings 41 are provided in the hollow shaft, through which cooling oil, delivered to the interior of the multi-disc clutch 33, can reach the clutch discs 37, 39. The inner disc carrier 38 is held rotatably around the rotational axis A relative to the housing 35 by means of a radial bearing 43 and is axially supported by means of an axial bearing 44 relative to the housing 35. For sealing purposes, a radial shaft sealing ring 45 sits between the housing 35 and the inner disc carrier 38. The outer disc carrier 36 is formed cup-shaped and comprises a cylindrical envelope portion, a bottom 46 and a hub 47 with an inner toothing. Into the hub 47, a not shown connection shaft can be inserted non-rotatably, which is to be held with its free end in a bore 49 of the inner disc carrier 38, which bore 49 is provided with the radial bearing 48. The envelope portion, the bottom 46 and the hub 47 are formed integrally and form together the cage of the multi-disc clutch 33.

The disc set 40 is axially supported on a support disc 50, which is fixedly connected to the inner disc carrier 38 and which again is axially supported on a securing ring 52, inserted into an annular groove of the inner disc carrier 38. The disc set 40 is axially acted upon by a pressure disc 53, which is held in a corresponding recess of a pressure plate 54. Between the pressure plate 54 and the inner disc carrier 38, spring means 55 in form of Belleville spring washers are active, which act upon the pressure plate 54 and the disc set 40 in axial opposite directions, i.e. are effective in the sense of releasing the disc clutch 33. The spring means 55 are axially supported on a securing ring 56, fixed relative to the inner disc carrier 38. Between the bottom 46 of the outer disc carrier 36 and the end of the inner disc carrier 38, neighboring the same, a sealing ring 51 in form of a plastic ring is inserted, which prevents, that cooling oil, delivered into the clutch cage, flows on the inside of the bottom radially to the outside, without contacting the disc set. A further purpose of the plastic ring 51 is to hold the outer disc carrier 36 at an axial distance to the inner disc carrier 38.

To cool and to lubricate the multi-disc clutch 33, the oil scoop assembly 2 is provided, which delivers oil from the oil sump arranged in the housing 35 into the interior of the multi-disc clutch 33. It is visible, that the oil return element 3 with its flange portion 19 is axially supported on a radial shoulder 27 of the housing 35 and is fixed by at least one screw connection 28 to the housing 35. In this case, the screw connection 28 serves also as a rotational retainment, so that it is ensured, that the wiper 10 is always held in the upper portion of the housing 35 and that the channel 6 is directed vertically downwards. The annular channel 7 is arranged coaxially to the rotational axis A of the multi-disc clutch 33 and forms a central bore 29, through which the shaft, to be connected non-rotatably to the hub 47, can be passed. The oil scoop wheel 4 is mounted with its annular disc 22 to the bottom 46 of the outer disc carrier 36, i.e. preferably screwed. The screws 30, which are visible in FIG. 3, are screwed into threaded bores in the bottom 46. The bottom 46 and the annular disc 22 have axial openings 23, 31, which are arranged corresponding to each other, so that the cooling oil can get from the annular chamber 7 through the openings 23, 31 into the interior of the multi-disc clutch 33, to cool the disc set 40 and to lubricate the rotating components.

It is visible, that the oil return element 3 is fixed in such a way in the housing 35, that the wiper 10 is aligned parallel to the longitudinal axis A and, thus, along the outer face of the outer disc carrier 36. In this way it is achieved, that oil, sticking to the outer face 21 of the outer disc carrier 36 after running through the oil sump, is wiped-off by the wiper 10 and is guided to the entering opening 8 into the channel 6. To be able to guide as much oil as possible into the channel 8, the wiper 10 extends in the axial direction along the largest part of the outer disc carrier 36. For the largest possible oil volume flow it is further provided, that the oil return element 3 is held in the housing 35 in such a way, that the radial gap formed between the wiper 10 and the outer disc carrier 36 is minimal. But, a touching contact between the wiper 10 and the cylindrical outer face of the outer disc carrier 36 should be prevented, to prevent frictional losses.

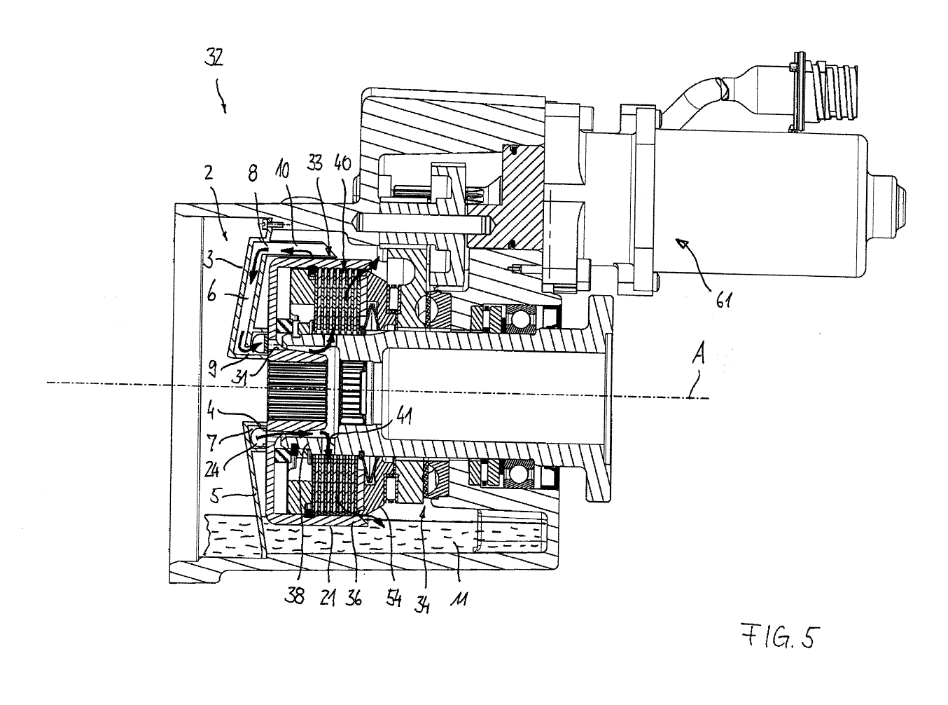

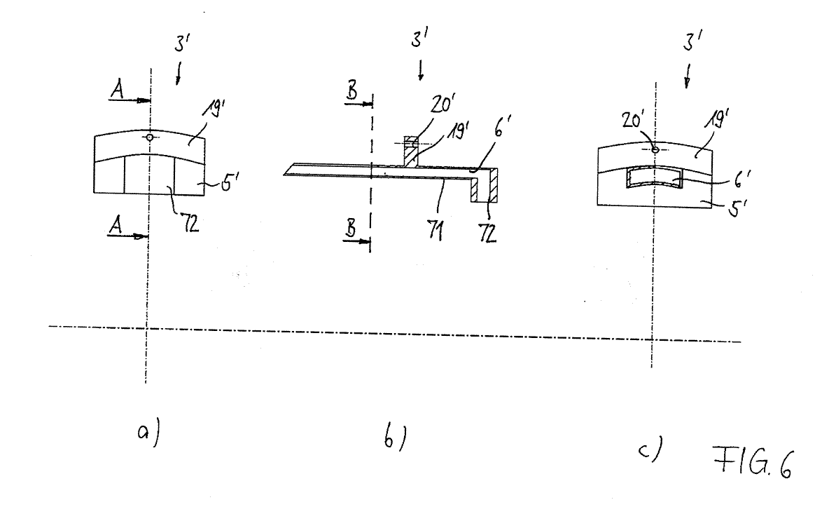

The path of the cooling oil flow is shown in FIG. 5 by means of drawn-in arrows. From this, it can be taken, that the oil is wiped-off by the wiper 10 from the upper face 21 of the outer disc carrier 36 and is delivered through the entering opening 8 into the radial channel 6. Because of the gravitational force, the oil flows in the radial channel 6 downwards and reaches through the connection opening 9 into the annular channel 7. From there, the oil is pumped, because of the rotation of the oil scoop wheel 4, by means of the blades 24 through the through openings 31 into the interior of the multi-disc clutch. Here, the oil flows initially in an axial direction within the inner disc carrier 38, formed as a hollow shaft, up to the radial through openings 41. The oil gets, because of the centrifugal forces, through the through openings 41 to the disc set 40, where it flows between the discs outwards and, thus, takes up the frictional heat of the clutch discs and transports it away. Radially outwardly, the oil flows then through the circumferentially extending gaps, formed between the outer disc carrier 36 and the pressure plate 54, out off the inner chamber of the disc clutch 33 into the oil sump 11 formed interior of the housing 35. Because of the rotation of the outer disc carrier 36 in the oil sump 11, an oil layer adheres to the outer face, which is transported upwards and is wiped-off by the wiper 10. Here the cycle starts again.

The axial actuating device 34, provided for actuating the disc clutch 33, is formed in the shape of a ball ramp assembly, whereas other actuation mechanisms, as for example hydraulic actuators, are also possible.

The ball ramp arrangement 34 comprises two discs, rotatable relative to each other, namely a support disc 57 and a setting disc 58, of which the support disc 57 is axially supported relative to the stationary housing 35 and of which the setting disc 58 is axially displaceable. The two discs 57, 58 have in their end faces, facing each other, several circumferentially distributed ball grooves 59, 60 with gradients of opposite directions. Respectively, two ball grooves 59, 60, arranged opposite each other and extending in circumferential direction, form a pair and take-up, respectively, one ball, on which the discs 57, 58 are axially supported. The balls are held in circumferential direction in a cage 62, held axially between the two discs 57, 58. Here the balls are not visible, as they are arranged outside the shown sectional plane. The depth of one pair of ball grooves 59, 60 is variable along the circumference, so that a rotation of the discs 57, 58 relative to each other leads to an axial displacement and thus, to an actuation of the pressure plate 54 of the disc clutch 33. In this case, the support disc 57 rests in a recess of the housing 35 in a non-rotational manner. The setting disc 58 is radially held by means of the balls, resting in the ball grooves relative to the support disc 57 and can be rotatably driven by means of a toothed segment 63 around the rotational axis A. Axially between the setting disc 58 and the pressure plate 54, an axial bearing 64 is interconnected, which enables a transmission of the axial forces with simultaneous relative rotational movement.

When the frictional clutch is completely released, the two discs 57, 58 are arranged in the most possible approximate position relative to each other. When rotating the setting disc 58 in a corresponding manner, the balls run in the ball grooves 12, 13 in areas of lower depth. Thus, an expansion takes place between the discs 57, 58, wherein the setting disc 58 is moved axially in the direction towards the disc set 40 and acts thereupon via the axial bearing 64 and the pressure plate 54. Corresponding to the rotation of the setting disc 58, the disc clutch 33 is locked to a predetermined extent, and a coupling of the outer disc carrier 36 to the inner disc carrier 38 is achieved. The spring means 55, formed as Belleville spring washers, cause, that the setting disc 58 is displaced again into its original starting position in the direction of the support disc 57, when the electromotor 61 is not actuated.

The ball ramp assembly 34 can be driven via a step-down transmission by the electromotor 61, which is flange-mounted on the housing 35. The step-down transmission comprises a pinion 65 with two straight toothings 66, 67, which is rotatably mounted on a bolt 68 parallel to the rotational axis A. The straight toothing 66 of larger diameter is meshing with the drive shaft 69 of the electromotor 61, while the straight toothing 67 of smaller diameter meshes with the tooth segment 63 of the adjustment disc 58. The bolt 68 rests with one end in a bore of the housing 35 and is held with its second end in a lid 70 inserted into the housing 35. The lid 70 sits in a bore of the housing 35 in a sealed manner.

In the following FIGS. 6 and 7 are described together. The configuration of the here shown oil scoop unit 2′ is similar to that of FIGS. 1 and 2, so that concerning joint features it is referred to the above description. The same or corresponding components, respectively, are provided with reference numerals added with one quotation mark.

The oil return element 3′ shown in FIG. 6 forms together with the oil scoop wheel 4′ shown in FIG. 7 the oil scoop unit 2′. It is visible, that the oil return element 3′ is limited to its functional components. It comprises a wiper 10′ extending in the axial direction and which, when seen in a cross-section, has a C-like profile, a tubular channel 6′ starting therefrom, as well as on its upper side an attachment element 19′. The attachment element 19′ is formed like a radial attachment, which abuts a shoulder of the housing and is mountable thereto by means of a screw connection. The tubular channel 6′ has directly following the wiper 10′ initially a first channel portion 71, extending in an axial direction and ending in a second channel portion 72, extending radially. In this case, the second channel portion 72 serves for connection to a not shown connection channel. The rear wall of the second channel portion 72 is formed by a base body 5′, which has radially inwardly a flat surface for the rotational retainment relative to a housing, not shown here.

The oil scoop wheel 4′, which is shown as a separate part in FIGS. 7a and 7b, comprises an annular disc 22′ with a plurality of circumferentially distributed openings 23′ and blades 24′, projecting radially from the annular disc 22′ and which are arranged, respectively, in circumferential direction neighboring the openings 23′. It is visible, that the blades 24′ have in a radial view a blade-like shape, so that they, when they are rotating around the rotational axis in a preferred direction, deliver oil radially inwards into the openings 23′, which are arranged in front in circumferential direction. The annular disc 22′ has a central bore 26′, so that it can be pushed onto a rotating machine part, especially an inner disc carrier. For this, the fixation on the machine part can be carried out, for example, by means of an interference fit or screw connections.

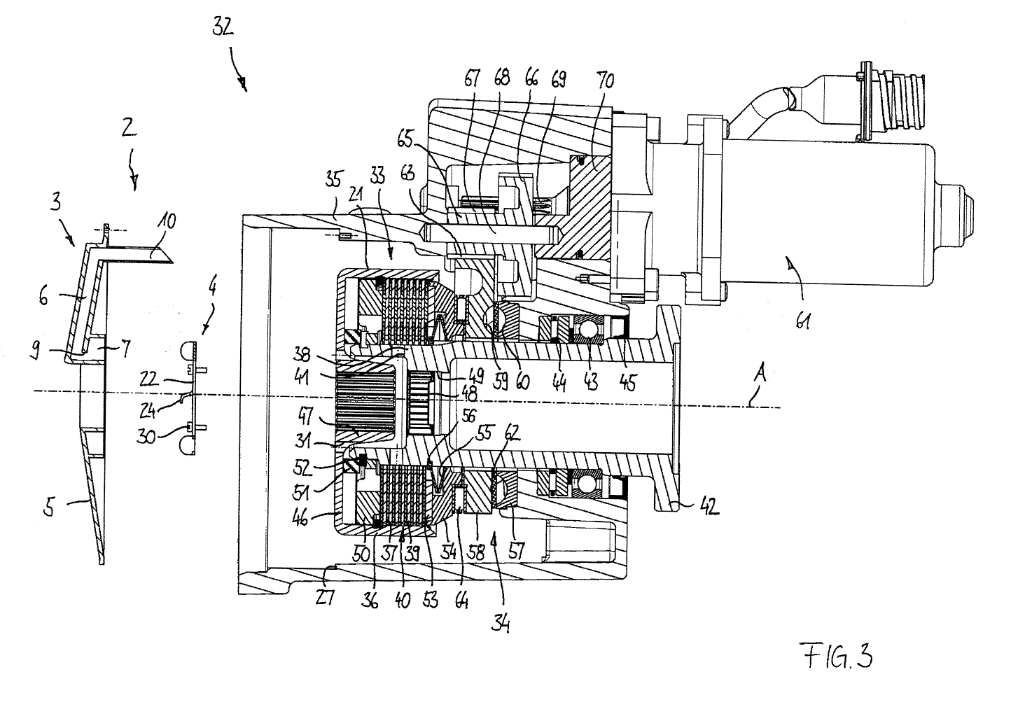

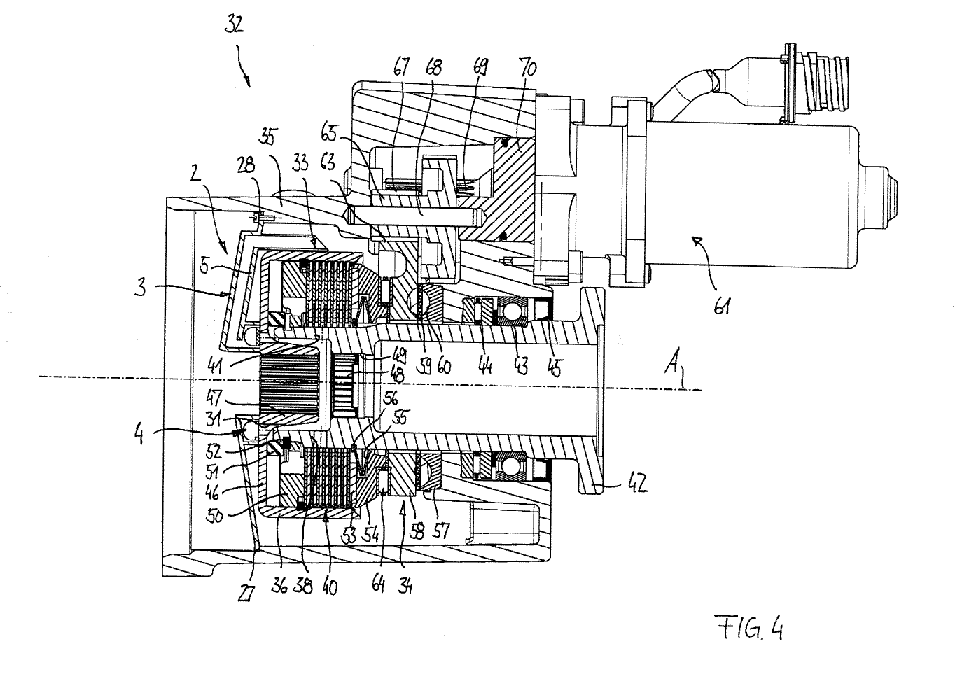

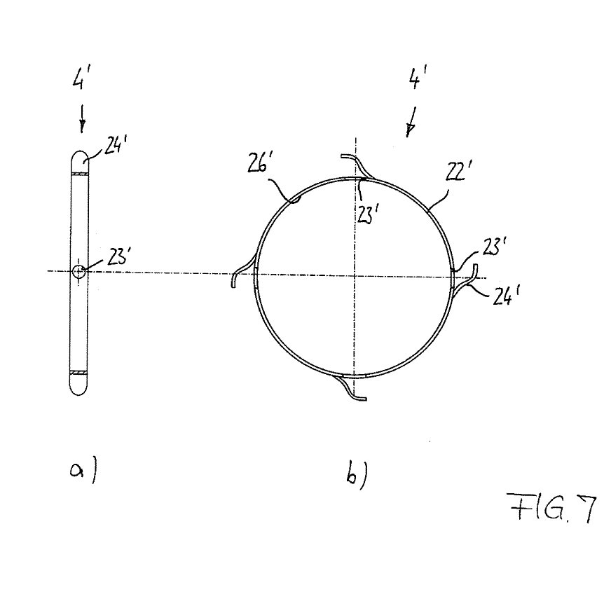

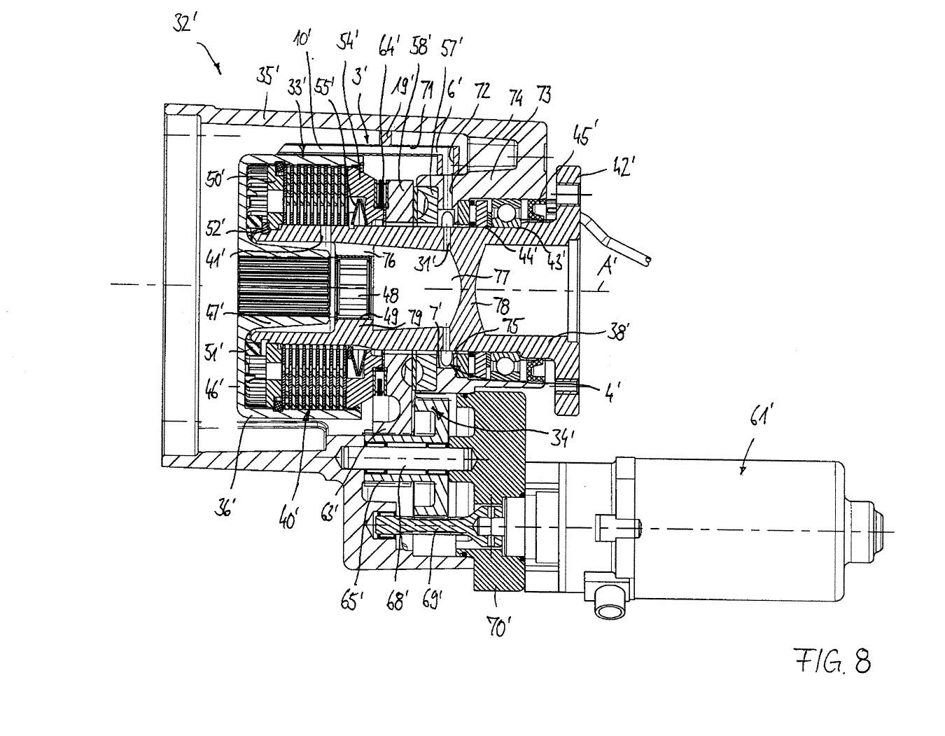

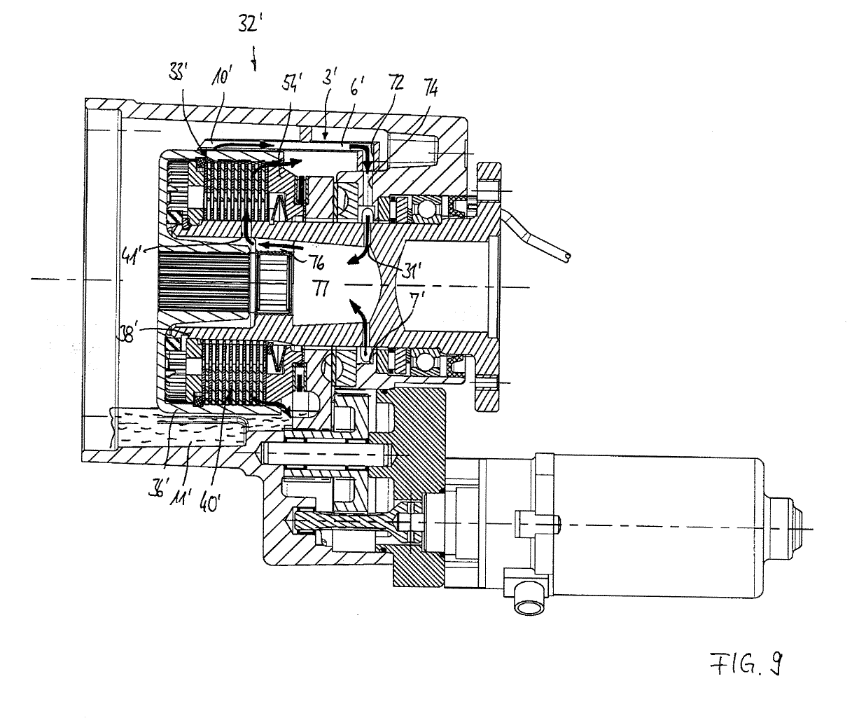

In the following FIGS. 8 and 9 are described together. These show a clutch arrangement 32′ according to the invention in a second embodiment, which corresponds generally to that of FIGS. 4 and 5. Insofar it is referred to the above description concerning the commonalities, wherein the same or corresponding components are provided with a reference numeral with one quotation mark. In the following mainly the differences are described.

Here, the longitudinal sectional view through the clutch 32′ is selected such, that the electromotor 61′ can be seen in the lower half of the drawing, wherein the structure and function is identical to that of FIG. 4. It is visible, that the present clutch arrangement 32′ comprises an oil scoop assembly 2′ according to FIGS. 6 and 7 for cooling and lubricating the multi-disc clutch 33′, which delivers oil from the oil sump arranged in the housing 35′ into the interior of the multi-disc clutch 33′. The oil return element 3′ is supported axially with its attachment portion 19′ on a radial shoulder of the housing 35′, not shown here, and is fixed by means of screws relative thereto. Here, the base body 5′ or the second channel portion 72 abuts a sleeve portion 73 of the housing 35′ extending coaxially to the rotational axis A′. The flattened base body 5′ serves as a rotational retainment of the oil return element 3′ relative the sleeve portion 73, so that it is ensured, that the wiper 10′ abuts at a defined position in the upper area of the outer disc carrier 36′ its outer face 21′. The channel 6′ of the oil return element 3′ ends in a connection channel 74, which extends in the sleeve portion 73 from radially outwards to radially inwards and which again ends in an annular channel 7′, which is open radially inwardly. In this case, the connection channel 74 is generally aligned vertically, so that oil, flowing into it, can flow because of the gravitational force radially inwardly in a direction towards the annular channel 7′. The annular channel 7′ is formed in a cylindrical inner face 75 of the sleeve portion 73 and is arranged axially between the axial bearing 44 and the support disc 57′. Here, the radial abutment face of the support disc 57′, with which it is axially supported relative to the housing 35′, forms the side wall of the annular channel 7′.

The inner disc carrier 38′ is formed to a greatest extent in the form of a hollow shaft, on which clutch-sided first end, the inner discs 39′ are non-rotatably mounted, and on which opposite second end, a flange 42′ for connecting to a not shown drive train is provided. In the axial overlapping area with the annular channel 7′, the inner disc carrier 38′ has a plurality of radial first through openings 31′, circumferentially distributed, and which end in a cavity 77, formed in the sleeve-like inner disc carrier 38. The cavity 77 is axially closed by a web 78 in the direction towards the flange 42′. In the area of the disc set 40′ a plurality of radial second through openings 41 are provided in the inner disc carrier 38, through which the cooling oil, delivered into the cavity 77, can reach the clutch discs 37′, 39′. It is visible, that the cavity 77 opens cone-like starting from the entry area of the first through openings 31′ in the direction towards the second through openings 41′. By means of this layout it is achieved, that the oil, which got into the cavity 77 through the through openings 31′, flows, when the inner disc carrier 38′ rotates, because of the centrifugal forces in the direction towards the second through openings 41′. In an area axially neighboring the hub 47′, the inner disc carrier 38′ has a bearing portion 79, in which the shaft, connected non-rotatably to the hub 47′, is to be rotatably received by means of a bearing 48′ concerning the rotational axis A. So that the oil, which is in the cavity 77, can flow in the direction towards the second through openings 41′, the bearing portion 79 has at least one axially extending transfer channel 76.

The path of the cooling oil flow is shown in FIG. 9 by means of indicated arrows. It is visible, that the oil is wiped-off by the wiper 10′ from the upper face 21′ of the outer disc carrier 36′ and is delivered into the channel 6′. The channel 6′ ends in the connection channel 74, formed in the housing 35′, and where the oil flows downwards because of the gravitational force and gets into the annular channel 7′. Starting therefrom, the oil is pumped, because of the rotation of the oil scoop wheel 4′, connected to the inner disc carrier 38, by means of the blades 24′ through the through openings 31′ into the interior of the inner disc carrier 38′. Hereby, the delivery process is carried out in the radial direction. However, any other arrangement is possible, in which the inner disc carrier and the housing are formed such, that a delivery can be carried out by means of the oil scoop wheel in axial direction. Within the inner disc carrier 38′ the oil flows in axial direction up to the radial second through openings 41′. The oil gets, because of the centrifugal forces, through the second through openings 41′ to the disc set 40′, where it flows between the discs 38′, 39′ outwardly and takes up the frictional heat of the clutch discs and transports this away. Radially outwardly the oil flows then through the gaps formed between the outer disc carrier 36′ and the pressure plate 54′ out off the inner chamber of the disc clutch 33′ into the oil sump 11′ formed inside the housing 35′. By means of the rotation of the outer disc carrier 36′ in the oil sump 11, an oil layer remains to adhere on the outer face 21′, which is transported upwards and is wiped-off by the wiper 10′. Here the cycle starts again.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. An oil scoop assembly comprising: a stationary housing; a plurality of machine parts rotatable within said housing relative to each other around a rotational axis (A),
an oil return element configured to connect to said housing, said oil return element including a wiper for abutting an outer face of one of said machine parts;
at least one channel which is supplied with oil by said wiper and which ends in an annular channel extending coaxially to said rotational axis (A); and
an oil scoop wheel configured to connect to one of said machine parts, said oil scoop wheel including a plurality of blades distributed around said rotational axis (A) and which extend into said annular channel wherein when said oil scoop wheel rotates relative to said oil return element, said plurality of blades deliver oil from said annular channel.

2. An oil scoop assembly according to claim 1, wherein said oil scoop wheel is connectable to said machine part whose outer face is abutted by said wiper of said oil return element.

3. An oil scoop assembly according to claim 2, wherein said wiper, said at least one channel and said annular channel form one piece and form together said oil return element.

4. An oil scoop assembly according to claim 2, wherein said at least one channel from said wiper to said annular channel extends generally radially.

5. An oil scoop assembly according to claim 2, wherein said annular channel, when seen in a longitudinal sectional view, has an approximately C-like profile, which is laterally open.

6. An oil scoop assembly according to claim 2, wherein said oil return element includes a base body, on which said at least one channel and said annular channel are arranged.

7. An oil scoop assembly according to claim 6, wherein said base body is formed disc-like and includes a through opening connecting said at least one channel with said annular channel.

8. An oil scoop assembly according to claim 2, wherein said oil scoop wheel comprises a ring with axial through openings, wherein said blades are arranged in circumferential direction neighbouring said axial through openings and project from said ring in a blade-like fashion to deliver oil through said axial through openings when said machine part rotates in a preferred rotational direction.

9. An oil scoop assembly according to claim 1, wherein said oil scoop wheel is configured to connect to a different one of said machine parts than the machine part which said oil return element abuts with said wiper.

10. An oil scoop assembly according to claim 9, wherein said wiper and said annular channel are formed integrally and form together said oil return element.

11. An oil scoop assembly according to claim 9, wherein said oil return element, with said at least one channel, is connected to a connection channel formed in said housing and ending in said annular channel.

12. An oil scoop assembly according to claim 9, wherein said annular channel in said housing is opened radially inwardly.

13. An oil scoop assembly according to claim 9, wherein said oil scoop wheel comprises a ring with radial through openings, wherein said blades are arranged in circumferential direction neighbouring said radial through openings and project from said ring in a blade-like fashion to deliver, when rotating in a preferred rotational direction, oil through said axial through openings radially inwardly.

14. An oil scoop assembly according to claim 1, wherein said wiper has, in cross-section, a generally C-like profile.

15. A multi-disc clutch with an oil scoop assembly, comprising:
an outer disc carrier including outer discs, said outer disc carrier rotatable around a rotational axis (A) and running in an oil sump;
an inner disc carrier including inner discs, said inner disc carrier rotatably held around said rotational axis (A) relative to said outer disc carrier in a housing, wherein said inner discs and said outer discs are arranged axially alternatingly and form a disc set;
a bottom part formed onto one of said inner or outer disc carriers, having a plurality of several circumferentially distributed axial through openings, said bottom part delimits a ring-like clutch chamber formed between said inner and said outer carriers;
an oil return element connected to said housing, including a wiper abutting, above the oil sump, an outer face of said outer disc carrier, a channel connected to said wiper and an annular channel connected to said channel and extending coaxially to said rotational axis (A); and
an oil scoop wheel, connected to said bottom part, with a plurality of blades distributed in circumferential direction and arranged in the area of said axial through openings, said blades enter said annular channel and, when said bottom part rotates relative to said housing, deliver oil from said annular channel through said axial through openings to a clutch chamber.

16. A multi-disc clutch according to claim 15, wherein said oil return element is arranged in said housing such that said channel is aligned generally vertically.

17. A multi-disc clutch according to claim 15, wherein said bottom part and said outer disc carrier form one part; wherein a hub is formed onto a radial inner end of said bottom part, into said hub a shaft can be inserted in a rotationally fixed way.

18. A multi-disc clutch according to claim 17, wherein said inner disc carrier is formed sleeve-like and has in the area of said disc set radial through openings, wherein said hub extends axially into said inner disc carrier.

19. A multi-disc clutch with an oil scoop assembly, comprising:
a housing with a sleeve portion, in which radially inwardly an annular channel is formed, extending coaxially to a rotational axis (A′);
an inner disc carrier including inner discs, said inner disc carrier being rotatably held in said housing around said rotational axis (A′), wherein said inner disc carrier is formed sleeve-like and has in the area of said annular channel a plurality of circumferentially distributed radial through openings;
an outer disc carrier including outer discs, said outer disc carrier being rotatably held relative to said inner disc carrier around said rotational axis (A′) and running in an oil sump, wherein said inner discs and said outer discs are arranged axially alternatingly and form a disc set;
an oil return element, connected to said housing and which has a wiper abutting, above the oil sump, an outer face of said outer disc carrier, said oil return element further includes a channel connected to said wiper, said channel connected to said annular channel for the oil supply; and
an oil scoop wheel connected to said inner disc carrier, having a plurality of circumferentially distributed blades which are arranged in the area of said radial through openings and extend into said annular channel; wherein when said inner disc carrier rotates relative to said housing, said blades deliver oil from said annular channel through said radial through openings to a clutch chamber.

20. A multi-disc clutch according to claim 19, wherein said sleeve portion has a connection channel with an entering opening, arranged outwards and in which said channel ends, and an exit opening, arranged inwards and ending in said annular channel.

21. A multi-disc clutch according to claim 20, wherein said connection channel is, in the mounted condition of the multi-disc clutch, orientated generally vertically.

22. A multi-disc clutch according to claim 19, wherein said inner disc carrier has, in the area of said disc set, radial through openings.
